(19) United States
(12) Patent Application Publication
(10) Pub. No.: US 2011/0198104 A1
(43) Pub. Date: Aug. 18, 2011

(54) Stake driver

(76) Inventor: Kenneth R. Stockstill, Picayune, MS (US)

(21) Appl. No.: 12/660,095

(22) Filed: Feb. 18, 2010

(51) Int. Cl. E02D 7/06; B25D 17/02

(52) U.S. Cl. 173/128

(57) ABSTRACT

A stake driver for driving wood stakes into a soil has a rectangular hollow housing having an open top and an open bottom. The bottom portion is configured for receiving at least a part of the wood stake therein, while an elongated driving shaft extends from an interior of the housing upwardly above a top edge of the housing. The upper part of the driving shaft is configured for engagement by a power transmitting tool, such as for instance a jack hammer. A driving pad is secured to a bottom end of the driving shaft transversely to the longitudinal axis of the housing. At least one hammer plate is secured, through connection to a shaft sleeve, to the driving shaft above the driving pad. The hammer plate and the driving pad are each configured to move in an axial direction inside the housing and transmit a hammering force to the wood stake. The hammering force is partially absorbed by a compression spring positioned between the hammer plate and the driving pad.

### BACKGROUND OF THE INVENTION

This invention relates to a stake driver assembly to drive a stake or post into the ground or other support surface using a handheld power tool, such as for instance a jack hammer.

Stake and posts are extensively used in construction industry for supporting fences, retaining molds for concrete, and numerous other jobs. Driving stakes and posts into the ground is a labor intensive job. Conventionally, a stake is driven into the soil using a hammer that strikes the stake top, gradually embedding the stake. During this process, the tops of wood stakes become severely damaged. Sometimes, a stake splits requiring a new stake to be driven in place of the damaged stake.

The present invention contemplates elimination of drawbacks associated with conventional tools and provision of a stake driver assembly that can be used with a handheld power tool such as a jack hammer or a pneumatically-driven power tool.

### SUMMARY OF THE INVENTION

It is, therefore, an object of the present invention to provide a stake driver assembly that is configured to be powered by a handheld power tool.

It is another object of the invention to provide a stake driver assembly that is configured to drive stakes or posts into the ground to a desired depth.

It is a further object of the invention to provide a stake driver assembly that is configured to cap the top of a wood stake and receive hammering force from a power tool.

These and other objects of the invention are achieved through a provision of a stake driver assembly for driving wood stakes into a soil. The assembly comprises a rectangular hollow housing having an open top and an open bottom. The bottom portion is configured for receiving at least a part of the wood stake therein, while an elongated driving shaft extends from an interior of the housing upwardly above a top edge of the housing. The upper part of the driving shaft is configured for engagement by a power transmitting tool, such as for instance a jack hammer. A driving pad is secured to a bottom end of the driving shaft transversely to the longitudinal axis of the housing. At least one hammer plate is secured, through connection to a shaft sleeve, to the driving shaft above the driving pad. The hammer plate and the driving pad are each configured to move in an axial direction inside the housing and transmit a hammering force to the wood stake. The hammering force is partially absorbed by a compression spring positioned between the hammer plate and the driving pad.

The stake driver assembly allows driving of stakes without causing damage to the stakes, in an efficient, labor-saving manner.

### BRIEF DESCRIPTION OF THE DRAWINGS

Reference will now be made to the drawings, wherein like parts are designated by like numerals, ad wherein

FIG. 1 illustrates a front view of the stake driver for use with large (for instance 3½″×1½″) stakes, with a front wall of the housing removed to show interior details.

FIG. 2 is a side elevation of the stake driver of FIG. 1, with a portion of a sidewall removed to show interior details.

FIG. 3 is a top view of the stake driver shown in FIGS. 1 and 2.

FIG. 4 is a bottom view of the stake driver shown in FIGS. 1-3.

FIG. 5 illustrates a front view of the stake driver for use with smaller (for instance 2¾×1½″) stakes, with a front wall of the housing removed to show interior details.

FIG. 6 is a side elevation of the stake driver of FIG. 5, with a portion of a sidewall removed to show interior details.

FIG. 7 is a bottom view of the stake driver shown in FIGS. 5 and 6.

FIG. 8 is a top view of the stake driver shown in FIGS. 5-7.

### DETAIL DESCRIPTION OF THE INVENTION

Turning now to the drawings in more detail, numeral 10 designates a stake driver assembly according to the present invention. The stake driver assembly 10 comprises a hollow housing 12 having a top edge 14 and a bottom edge 16. The housing 12 has an open top and an open bottom, acting as a sleeve for a driving assembly 18 in its upper portion and as a cap for a wood stake 20—in its lower portion. In the exemplary embodiments shown in the drawings, the housing 12 has a generally rectangular cross-section, although other configurations can be employed depending on the shape of a stake to be driven.

The driving assembly 18 comprises an elongated driving shaft 22, which extends from the interior of the housing 12 upwardly above the top edge 14 of the housing 12 in a general alignment with the longitudinal axis of the housing 12. The driving shaft 22 can have a hexagonal cross-section, as shown in FIG. 3. A steel driving pad 24 is secured to a bottom of the driving shaft 22 transversely to a longitudinal axis of the housing 12. The steel driving pad 24 is configured to follow the configuration of the interior of the housing 12 with peripheral dimensions of the driving pad 24 being slightly smaller than the dimensions of the housing 12 interior. As can be seen in the drawings, a space is formed between the interior surface of the housing 12 and the driving pad 24.

A stop collar 26 is secured on the driving shaft 22 a distance above the top edge 14. The stop collar 26 acts a limiting means for engagement of the drive shaft 22 by a power tool, such as for instance a pneumatically operated jack hammer. One or more steel hammer plates 28, 29 are secured to the driving shaft 22 and the driving pad 24 in a generally parallel relationship to the driving pad 24 and transversely to the longitudinal axis of the housing 12. The hammer plates move inside the housing 12 in an axial direction inside the housing.

The hammer plates 28, 29 are secured using elongated bolts 30, 31 that extend from the driving pad 24 upwardly above the top edge 14 of the housing 12. The tops of the bolts 30, 31 are engaged with lock nuts and washers 32, 33, respectively, while the bottoms are affixed, as at 35, to the top of the driving pad 24. The bolts 30, 31 are secured on opposite sides of the shaft 22. The bolts 30, 31 can be case hardened bolts.

A compressible tension spring 34 is positioned in a surrounding relationship to the driving shaft 22 between the lower hammer plate 29 and the driving pad 24. An upper part of each bolt 30, 31 is surrounded by a tension spring 36, 38, respectively. The springs 36, 38 are tensioned between the upper hammer plate 28 and the retaining nuts 32, 33, normally urging the hammer plates 28, 29 downwardly.

A sleeve 40 is secured in a surrounding relationship to the driving shaft 22. The sleeve 40 extends from a top of the lower hammer plate 29 a distance above the edge 14 of the housing 12, aligning the driving shaft 22. The sleeve is fixedly secured to the hammer plate by welding or similar means. It is envisioned that in the embodiments where only one hammer plate is used, an annular groove can be made in the top of the hammer plate, with the groove receiving a portion of the sleeve 40 therein.

A grease fitting 42 is incorporated into the sleeve 40 to allow introduction of a lubricating substance into the space between the sleeve 40 and the driving shaft 22 facilitate vertical movement of the driving shaft 22 during a stake driving operation.

A pilot hole 46 is formed in a sidewall of the housing 12. The pilot opening 46 is configured to allow a nail or screw to be partially driven into the wood stake 20 positioned in the housing 12 in order to retain the wood stake in a desired position inside the housing 12 during operation.

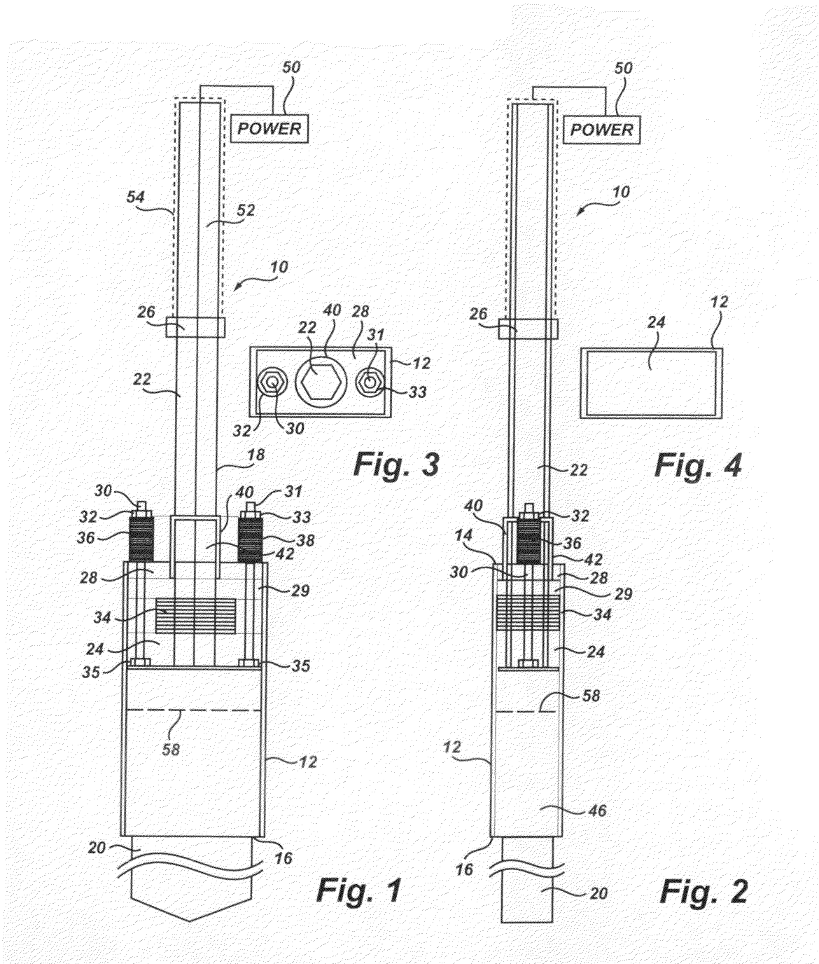

An upper portion 52 of the shaft 22, above the collar 26, is configured to be engaged with a jack hammer engaging part 54 shown schematically in phantom lines 54 in FIGS. 1 and 2. The jack hammer engaging part 54 is adapted for connection to a power source, for instance a pneumatic power source 50.

In operation, a user measures a distance, to which the wood stake 20 must be driven into the soil and then draws a line 58 on the outside of the sidewall of the housing 12. The user then inserts the wood stake 20 through a bottom opening of the housing 12, forcing the top of the wood stake 20 to contact the driving pad 24. A nail or screw is then hammered into the wood stake 20 through the opening 46, securing the wood stake in an aligned positioned in the housing 12.

The user then connects the upper portion 52 of the shaft 22 to a jack hammer engaging part 54 and thus—to the power source 50. Once activated, the power source applies hammering action on the drive shaft 22, which transmits the hammering action, through the driving pad 24, to the stake 20. The springs 32, 33 and 34 absorb some of the driving force, protecting the hammer head (plates 28, 29 and driving pad 24) from damage.

The housing 12 moves downwardly until the user observe that the housing has reached a desired position indicated by the selected line 58. The housing 12, being spaced from the actively moving parts, is isolated from damage as the stake 20 is embedded into the soil. Once the stake is embedded to the desired depth, the user removes the retaining nail or screw, disengaging the assembly 10 from the wood stake. The assembly 10 can then be used for driving successive wood stakes into the ground.

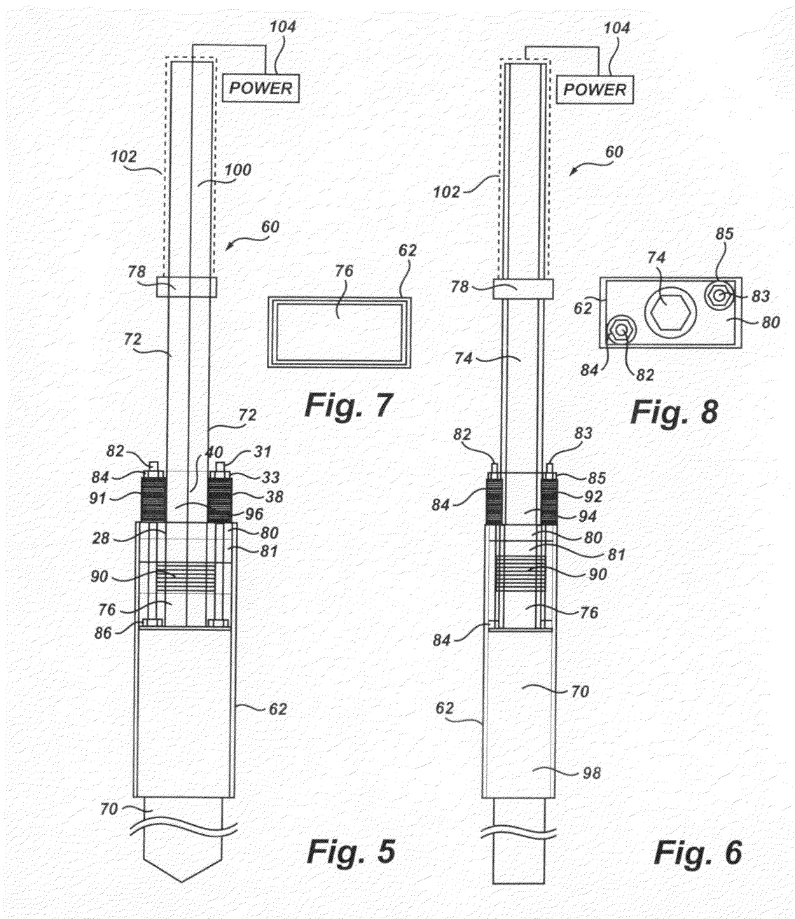

The embodiment shown in FIG. 5-8 is similar in many respects to the embodiment shown in FIGS. 1-4, except that it is configured to accommodate smaller wood stakes, for instance 2¾×1½″ wood stakes. In this embodiment the horizontal dimensions of two sides of the rectangular housing are smaller, so that smaller size wood stakes can be properly guided and retained in alignment inside the lower portion of the housing.

The stake driver assembly 60 also comprises a housing 62 having a top edge 64 and a bottom edge 66. The housing 62 has an open top and an open bottom, allowing a wood stake 70 to be inserted from the bottom and receiving a driving assembly 72, from the top. In the exemplary embodiments shown in FIGS. 5-8, the housing 62 has a generally rectangular cross-section, although other configurations can be employed depending on the shape of a stake to be driven.

The driving assembly 72 comprises an elongated driving shaft 74, which extends from the interior of the housing 62 upwardly from the top edge 64 of the housing 62 in a general alignment with the longitudinal axis of the housing. The driving shaft 74 can have a hexagonal cross-section, as shown in FIG. 8.

A steel driving pad 76 is secured to a bottom of the driving shaft 74 transversely to a longitudinal axis of the housing 62. The steel driving pad 76, similar to the driving pad 24, is configured to freely move inside the housing 62 in alignment with the longitudinal axis of the housing 62 during operation of the stake driver 10.

A stop collar 78 is secured on the driving shaft 74 a distance above the top edge 64. The stop collar 78 acts a limiting means for engagement of the driving shaft 74 by a power tool, such as for instance a pneumatically operated jack hammer. One or more steel hammer plates 80, 81 are secured to the driving shaft 74 and the driving pad 76 using elongated bolts 82, 83 that extend from the driving pad 76 upwardly above the top edge 64 of the housing 12.

The tops of the bolts 82, 83 are engaged with lock nuts and washers 84, 85, respectively, while the bottoms are affixed, as at 86, to the top of the driving pad 76. The bolts 82, 83 are secured on opposite sides of the shaft 74, closer to the corners of the rectangular periphery of the stake driver 60. The bolts 82, 83 can be case hardened bolts.

A compressible tension spring 90 is positioned in a surrounding relationship to the driving shaft 74 between the lower hammer plate 81 and the driving pad 24. An upper part of each bolt 82, 83 is surrounded by a tension spring 91, 92 respectively. The springs 91, 92 are tensioned between the upper hammer plate 80 and the retaining nuts 84, 85, normally urging the hammer plates 80, 81 downwardly.

A sleeve 94 is secured in a surrounding relationship to the driving shaft 74. The sleeve 94 extends from a top of the hammer plate 81 a distance above the edge 64 of the housing 62. A grease fitting 96 is incorporated into the sleeve 94 to allow introduction of a lubricating substance into the space between the sleeve 94 and the driving shaft 74 in order to facilitate vertical movement of the driving shaft 74 during a stake driving operation.

A pilot hole 98 is formed in a sidewall of the housing 12. The pilot opening 98 is configured to allow a nail or screw to be partially driven into the wood stake 70 after the wood stake 70 has been positioned in the housing 62. The retaining nail helps to retain the wood stake 70 in a desired position inside the housing 62 during the operation.

Similarly to the embodiment of FIGS. 1-4, an upper portion 100 of the driving shaft 74, above the collar 78, is configured to be engaged with a jack hammer engaging part 102 shown schematically in phantom lines in FIGS. 5 and 6. The jack hammer engaging part 102 is adapted for connection to a power source, for instance a pneumatic power source 104.

The operation of the stake driving assembly 60 is similar to the operation of the stake driving assembly 10 described above. The wood stakes driven into the soil using the stake driving assemblies of the instant invention remain undamaged, and the tops of the stakes are not split. The housings guide the stake into the ground in the selected location in a proper vertical alignment.

The stake driving assembly of the instant invention is portable, efficient, and saves time and human energy during use. The tool can be moved around the job site allowing the worker to accurately put the stakes in the desired locations. Further, saving the stakes is possible because after the job is done, because the stakes have not been shattered, they can be reused. The grease fitting in the junction between the sleeve and the shaft facilitates sliding movement of the shaft and prevents uneven motions of the shaft. The non-rigid connection between the hammering elements and the housing allows for repeated performances without damage.

Many changes and modifications can be made in the design of the present invention without departing from the spirit thereof. I, therefore, pray that my rights to the present invention be limited only by the scope of the appended claims.

1. A stake driver assembly for driving stakes into a soil, comprising:
a hollow housing having a bottom portion configured for detachably receiving at least a part of the stake therein;
an elongated driving shaft extending from an interior of the housing upwardly above a top edge of the housing substantially along a central longitudinal axis of the housing, said driving shaft having an upper portion configured for connection to a hammering power source;
a driving pad secured to a bottom end of the driving shaft in a substantially transverse relationship to the longitudinal axis of the housing, said driving pad being configured to move in an axial direction inside the housing and engage an upper end of the stake while transmitting a hammering force to said stake;
at least one hammer plate positioned in said housing above the driving pad, said at least one hammer plate being secured to the driving shaft, said at least one hammer plate moving in an axial direction inside the housing;
a means for securing the driving pad and said at least one hammer plate in a spaced-apart relationship.

2. The assembly of claim 1, wherein said means for securing the driving pad to the at least one hammer plate comprises a plurality of elongated bolts extending from said at least one hammer plate and affixed at bolts' lower ends to the driving pad.

3. The assembly of claim 2, wherein a compressible tension spring is positioned between said at least one hammer plate and the driving pad in a surrounding relationship about the driving shaft, said tension spring absorbing hammering force acting on said driving shaft without transmitting full hammering action to the driving pad and said at least one hammer plate.

4. The assembly of claim 2, wherein a lock nut is secured on a top of each of the elongated bolts above said at least one hammer plate.

5. The assembly of claim 4, further comprising a compression spring mounted on each of said elongated bolts and tensioned between said at least one hammer plate and said lock nut.

6. The assembly of claim 1, wherein said upper portion is configured for engagement by a power transmitting member.

7. The assembly of claim 6, wherein the driving shaft carries a collar in a portion extending above the top edge of the housing for limiting movement of the power transmitting member along the driving shaft.

8. The assembly of claim 1, wherein a sleeve is mounted in a surrounding relationship to said driving shaft above said at least one hammer plate, said sleeve being fixedly secured to said at least one hammer plate.

9. The assembly of claim 8, wherein said sleeve is provided with a grease fitting configured for admitting lubricant into a space between the sleeve and the driving shaft.

10. The assembly of claim 1, wherein said housing comprises a sidewall, and wherein an opening is formed in the sidewall, said opening being configured to allow a temporary securing member to be inserted therethrough for attachment to the stake and retaining the stake in a desired position inside the housing.

11. A stake driver assembly for driving wood stakes into a soil, comprising:
a hollow housing having a bottom portion configured for receiving at least a part of the wood stake therein;
an elongated driving shaft extending from an interior of the housing upwardly above a top edge of the housing and substantially along a central longitudinal axis of the housing, said driving shaft having an upper portion configured for connection to a power source supplying hammering force to the driving shaft;
a driving pad secured to a bottom end of the driving shaft in a substantially transverse relationship to the longitudinal axis of the housing, said driving pad being configured to move in an axial direction inside the housing and engage an upper end of the stake, while transmitting a hammering force to said stake;
at least one hammer plate positioned in said housing above the driving pad, said at least one hammer plate being secured to the driving shaft and configured for movement inside the housing in an axial direction;
a means for securing the driving pad and said at least one hammer plate in a spaced-apart relationship, said securing means comprising a plurality of elongated bolts extending from said at least one hammer plate and affixed at bolts' lower ends to the driving pad.

12. The assembly of claim 11, wherein said upper portion is configured for engagement by a power transmitting member extending from a power source.

13. The assembly of claim 12, wherein the driving shaft carries a collar in a portion extending above the top edge of the housing, said collar limiting movement of the power transmitting member along the driving shaft.

14. The assembly of claim 11, wherein a compressible tension spring is positioned between said at least one hammer plate and the driving pad in a surrounding relationship about the driving shaft, said tension spring absorbing hammering force acting on said driving shaft without transmitting full hammering action to the driving pad and said at least one hammer plate.

15. The assembly of claim 11, wherein a lock nut is secured on a top of each of the elongated bolts above said at least one hammer plate.

16. The assembly of claim 15, further comprising a compression spring mounted on each of said elongated bolts and tensioned between said at least one hammer plate and said lock nut.

17. The assembly of claim 11, wherein a sleeve is mounted in a surrounding relationship to en said driving shaft above said at least one hammer plate, said sleeve being fixedly secured to said at least one hammer plate.

18. The assembly of claim 17, wherein said sleeve is provided with a grease fitting configured for admitting lubricant into a space between the sleeve and the driving shaft.

19. The assembly of claim 11, wherein said housing comprises a sidewall, and wherein an opening is formed in the sidewall, said opening being configured to allow a temporary securing member to be inserted therethrough for attachment to the stake and retaining the stake in a desired position inside the housing.
